(19) United States
(12) Patent Application Publication
(10) Pub. No.: US 2018/0066525 A1
(43) Pub. Date: Mar. 8, 2018

(54) Air cooled turbine rotor blade for closed loop cooling

(71) Applicants: James P. Downs, Hobe Sound, FL (US); Christopher K. Rawlings, Stuart, FL (US)

(72) Inventors: James P. Downs, Hobe Sound, FL (US); Christopher K. Rawlings, Stuart, FL (US)

(21) Appl. No.: 15/255,227

(22) Filed: Sep. 2, 2016

(51) Int. Cl. F01D 5/18; F01D 9/04; F01D 25/12

(52) U.S. Cl. CPC F01D 5/187; F01D 9/041; F05D 2260/202; F05D 2220/32; F01D 25/12

(57) ABSTRACT

A turbine rotor blade with a closed loop cooling circuit for an industrial gas turbine engine in which cooling air for the rotor blade is supplied and carried away to and from the rotor blade through the rotor shaft, and where the rotor blade includes a serpentine flow cooling circuit with an even number of legs or channels in which the cooling air is supplied to and discharge from the blade in the blade root. The closed loop rotor blade cooling circuit can be two four-pass serpentine flow cooling circuits or one six-pass serpentine flow cooling circuit.

### GOVERNMENT LICENSE RIGHTS

This invention was made with Government support under contract number DE-FE0023975 awarded by Department of Energy. The Government has certain rights in the invention.

### CROSS-REFERENCE TO RELATED APPLICATIONS

None.

### BACKGROUND OF THE INVENTION

### Field of the Invention

The present invention relates generally to a gas turbine engine, and more specifically to an air cooled turbine rotor blade for a closed loop cooling circuit in an industrial gas turbine engine.

Description of the Related Art Including Information Disclosed Under 37 CFR 1.97 and 1.98

In a gas turbine engine, compressed air is burned with a fuel in a combustor to produce a very high temperature gas stream that is then passed through a turbine that uses some of the power produced to drive a compressor and, in the case of an industrial gas turbine engine, an electric generator to produce electrical power. The higher the hot gas stream temperature entering the turbine, the more power the turbine can generate and the more efficient will be the engine. The turbine inlet temperature is limited to the material properties of the parts exposed to the hot gas stream and to the effectiveness of cooling of the parts. The coolant used to cool the turbine hot parts such as rotor blades and stator vanes is typically compressed air bled off from the compressor, and thus the more compressed air used for cooling lowers the efficiency of the engine since the work done on compressing the cooling air is discharged into the hot gas stream and does not perform any work on the compressor or electric generator. When most or all of the cooling air for the turbine hot parts is discharged into the hot gas stream, this is referred to as an open cooling circuit for the turbine.

FIG. 1 shows a prior art turbine rotor blade with an internal cooling circuit (U.S. Pat. No. 8,864,469 issued to Liang on Oct. 21, 2014 and entitled TURBINE ROTOR BLADE WITH SUPER COOLING). The FIG. 1 rotor blade cooling circuit includes two distinct cooling circuits with one for cooling the leading edge region of the airfoil and a second that includes a five-pass serpentine cooling circuit for cooling the mid-chord region with discharge for cooling the trailing edge region of the airfoil. The leading edge region cooling circuit 10 includes a single pass radial extending channel that feeds multiple rows of film cooling holes on the leading edge region and discharges all of the cooling air out onto the airfoil external surface as film cooling air. The mid-chord region serpentine cooling circuit includes legs 11-15 that pass upward and then downward to produce convection cooling of the hot wall surfaces on the pressure side and suction side walls of the airfoil. One or more rows of film cooling holes are connected to the serpentine legs to discharge film cooling air on the hottest surfaces of the airfoil walls. The remaining cooling air passing into the last leg 15 is discharged through the trailing edge region through a row of exit holes that discharge out the trailing edge of the airfoil. All of the cooling air supplied to the airfoil through the root is discharged into the hot gas stream to form an open loop cooling circuit.

FIG. 2 shows a prior art leading edge region cooling circuit in which cooling air is supplied to channel 17, passed through metering and impingement holes 18 into a leading edge region cooling channel 19, and then discharged through rows of film cooling holes 21 and 22 to provide film cooling to hot surfaces of the airfoil.

### BRIEF SUMMARY OF THE INVENTION

A turbine rotor blade with a closed loop cooling circuit for an industrial gas turbine engine in which the cooling air for the rotor blade is delivered to a combustor of the engine instead of discharged into the turbine hot gas stream. The rotor blade includes a serpentine flow cooling circuit in which the supply leg and discharge leg are both located in the blade root.

In a first embodiment, the closed loop cooling circuit includes a first four-pass aft flowing serpentine flow cooling circuit in a forward section of the blade airfoil and a second four-pass forward flowing serpentine flow cooling circuit in an aft section of the blade airfoil.

In a second embodiment, the closed loop cooling circuit includes a six-pass serpentine flow cooling circuit with a forward flowing direction having a first leg located adjacent to a trailing edge region of the blade airfoil and a last leg located adjacent to a leading edge region of the blade airfoil.

In both embodiments, an option is to use a row of exit holes or slots along the trailing edge and connected to the closed loop cooling circuit to provide cooling to the trailing edge in which some of the total cooling air is discharged into the turbine hot gas stream.

### BRIEF DESCRIPTION OF THE SEVERAL VIEWS OF THE DRAWINGS

FIG. 1 shows a prior art turbine rotor blade with a cooling circuit.

FIG. 2 shows a prior art turbine rotor blade with a leading edge region cooling circuit.

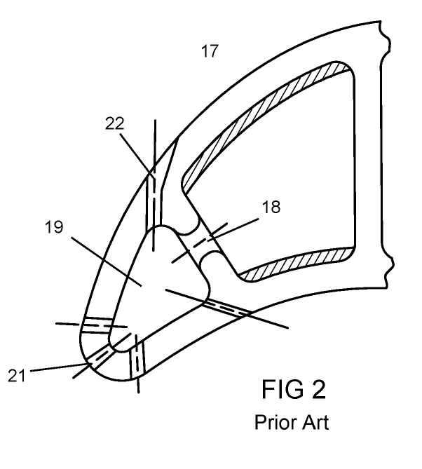

FIG. 3 shows a first embodiment of a turbine rotor blade with a closed loop cooling circuit for an industrial gas turbine engine.

FIG. 4 shows a second embodiment of a turbine rotor blade with a closed loop cooling circuit for an industrial gas turbine engine.

FIG. 5 shows a twin spool turbocharged industrial gas turbine engine with a closed loop cooling circuit for a turbine stator vane of the present invention.

### DETAILED DESCRIPTION OF THE INVENTION

The present invention is a gas turbine engine with a closed loop or substantially closed loop turbine rotor blade cooling circuit in which cooling air for the rotor blade is discharged into the combustor instead of into the turbine hot gas stream. By substantially closed loop, the inventors mean that most of the cooling air is passed into and then exits from the rotor blade that is not discharged into the turbine hot gas stream but reused in the combustor. A small amount of the cooling air can be used for film cooling of the leading edge region or at discharge slots in the trailing edge region to cool these parts of the blade. The closed loop cooled turbine rotor blade is intended for use in a twin spool industrial gas turbine engine in which the engine efficiency and the engine power output is greater than any of the prior art industrial engines currently existing.

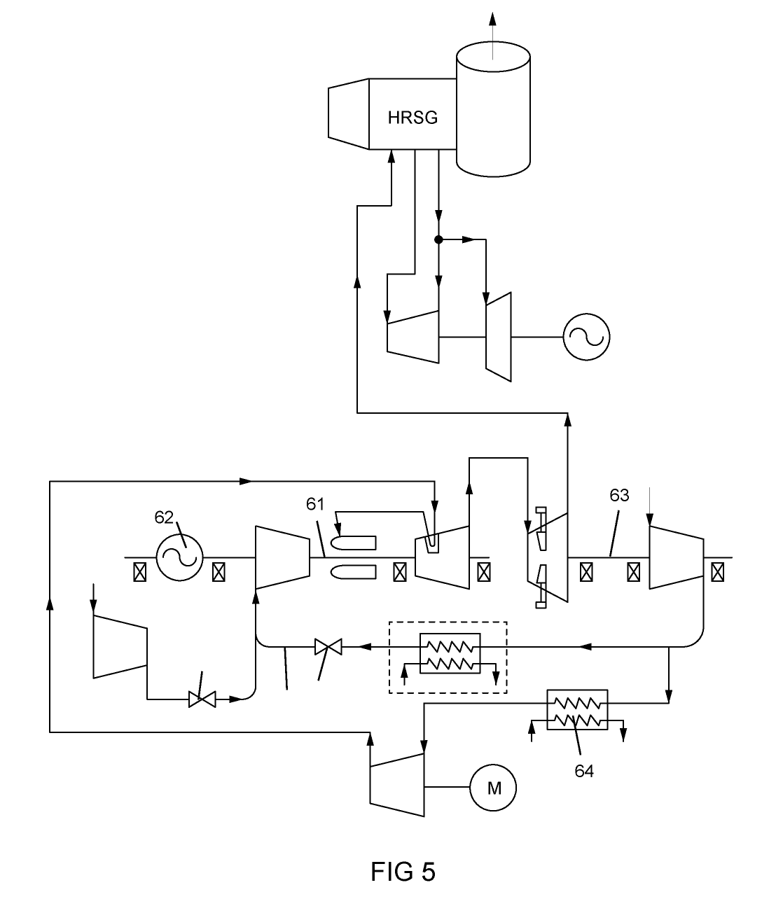

The twin spool industrial gas turbine engine with closed loop cooling is shown in FIG. 5 and includes a high spool 61 that directly drives an electric generator 62 and a low spool or a turbocharger 63 that supplies compressed air to a high pressure compressor of the high spool 61. Cooling air for a turbine stator vane or rotor blade is bled off from a compressed air line connecting the low pressure compressor of the low spool 63 to the high pressure compressor of the high spool 61. An intercooler is used to cool the compressed air from the low spool 63. FIG. 5 shows a stator vane being cooled, but a rotor blade can also be cooled in which the cooling air passes through the rotor shaft and returns through the rotor shaft to be discharged into the combustor of the high spool 61.

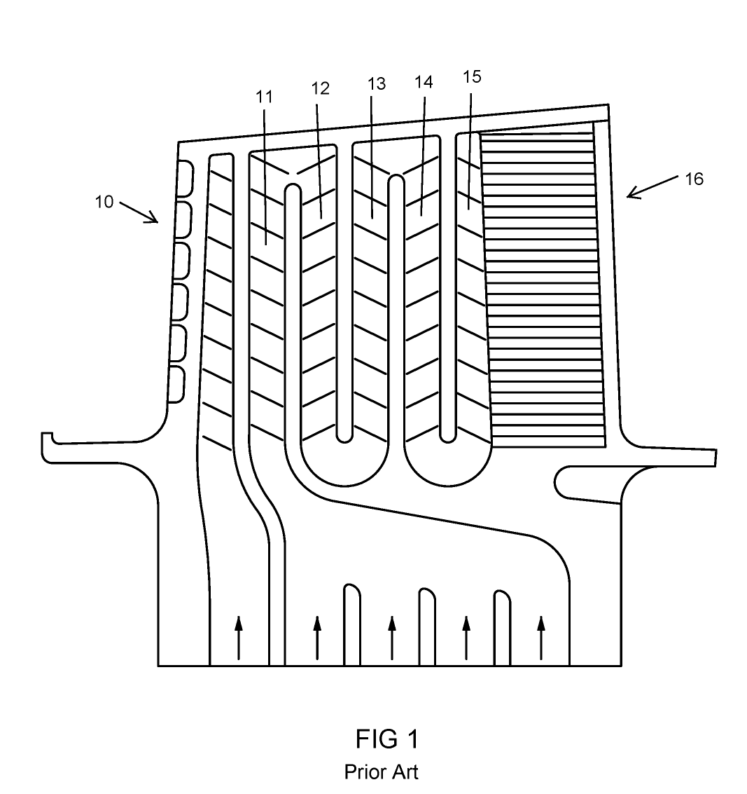

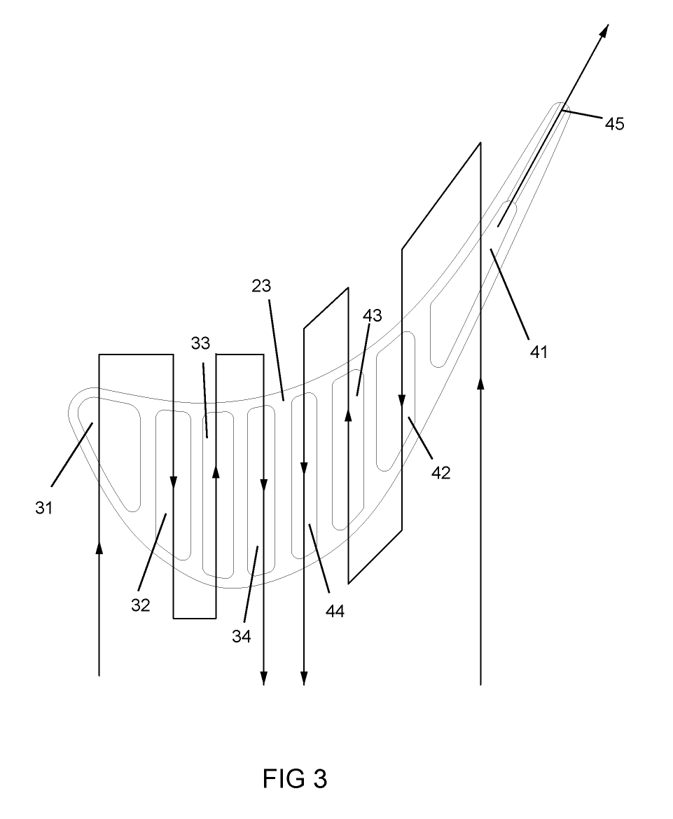

FIG. 3 shows a first embodiment of the air cooled turbine rotor blade for the closed loop cooling circuit of the present invention. The rotor blade 23 includes eight radial or spanwise extending cooling passages formed within the airfoil walls of the rotor blade and extends from the platform to the blade tip. The FIG. 3 embodiment includes two separate and distinct four-pass cooling circuit with a first to cool the forward section of the blade airfoil and the second to cool the aft section. The first four-pass cooling circuit includes four legs of channels 31-34 with the first leg 31 located adjacent to the leading edge of the blade airfoil. The second four-pass cooling circuit includes four legs of channels 41-44 with the first leg 41 located adjacent to the trailing edge region of the blade airfoil. The first four-pass cooling circuit 31-34 is an aft flowing serpentine flowing cooling circuit while the second four-pass cooling circuit 41-44 is a forward flowing serpentine flow cooling circuit. In both four-pass serpentine flow cooling circuit, the first leg and the last leg flow through the blade root. Thus, only an even number of legs or passages can be used in the closed loop rotor blade cooling circuit because the cooling air must be supplied to and discharge from the blade root and not at the blade tip as in the prior art FIG. 1 rotor blade which must use an odd number of legs or channels.

In the FIG. 3 rotor blade cooling circuit, an option is to use a row of exit holes or slots 45 in or along the trailing edge of the blade airfoil and connected to the first leg 41 of the serpentine flow cooling circuit to provide cooling to the trailing edge region of the rotor blade. Just a small amount of the total cooling air flows out through these exit holes and into the turbine hot gas stream, and thus this circuit is still considered to be closed loop.

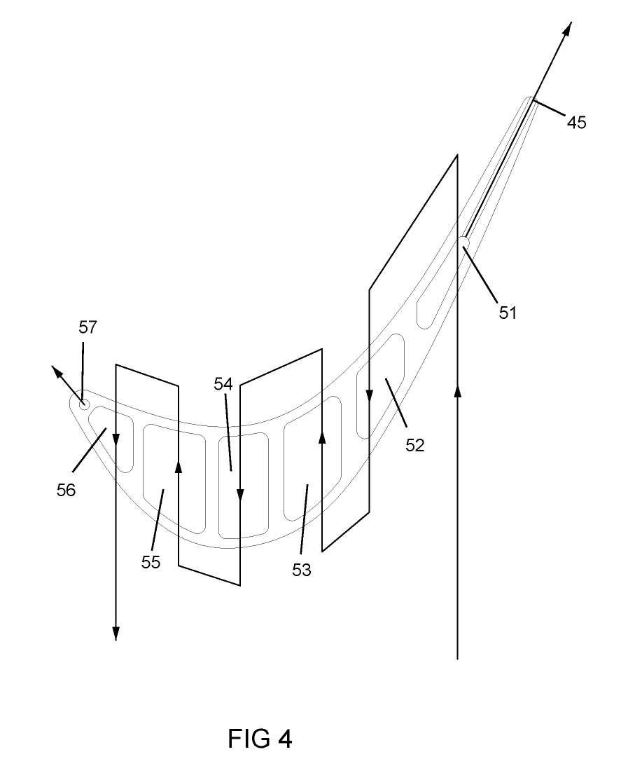

FIG. 4 shows a second embodiment of the air cooled turbine rotor blade for the closed loop cooling circuit of the present invention. The blade airfoil includes a single six-pass serpentine flow cooling circuit with legs 51-56 that form a forward flowing serpentine cooling circuit. The first leg 51 supplies cooling air through the blade root and flows along the trailing edge region of the blade airfoil. The remaining legs 52-56 flows in a serpentine path to the last leg 56 which is positioned adjacent to the leading edge region of the blade airfoil. As in the FIG. 3 embodiment, the legs 51-56 extend from the blade platform to the blade tip to provide for cooling of the entire airfoil walls. As in the FIG. 3 embodiment, the cooling air is supplied to the rotor blade and discharged from the rotor blade through the blade root.

As an option, the trailing edge region can be cooled using a row of exit holes or slots 45 in the trailing edge region and connected to the first leg 51. A second option is the use of rows of film cooling holes in the leading edge region in which cooling air can be supplied to a leading edge region cooling supply channel 57 from the root or bled off from the last leg 56. The FIG. 4 embodiment also has an even number of legs or channels in the serpentine circuit because the supply and discharge of the cooling air to and from the rotor blade must pass through the blade root.

We claim the following:

1. : An air cooled turbine rotor blade for a gas turbine engine comprising:
a turbine rotor blade with an airfoil extending from a root and a platform and having a blade tip;
a leading edge region and a trailing edge region with a pressure side wall and a suction side wall;
a substantially closed loop cooling circuit formed within the blade airfoil and having a first leg to supply cooling air to the closed loop cooling circuit through the blade root and a last leg to discharge cooling air from the closed loop cooling circuit through the blade root; and,
the number of legs is an even number of legs.

2. : The air cooled turbine rotor blade of claim 1, and further comprising:
the substantially closed loop cooling circuit includes a first serpentine flow cooling circuit with an even number of legs and a second serpentine flow cooling circuit with an even number of legs.

3. : The air cooled turbine rotor blade of claim 2, and further comprising:
the first serpentine flow cooling circuit is an aft flowing four-pass serpentine flow cooling circuit located in a forward side of the blade airfoil; and,
the second serpentine flow cooling circuit is a forward flowing four-pass serpentine flow cooling circuit located in an aft side of the blade airfoil.

4. : The air cooled turbine rotor blade of claim 1, and further comprising:
the substantially closed loop cooling circuit is a six-pass serpentine flow cooling circuit with a first leg located adjacent to the trailing edge region and a sixth leg located adjacent to the leading edge region of the blade airfoil.

5. : The air cooled turbine rotor blade of claim 1, and further comprising:
a row of exit holes or slots extending along the trailing edge of the blade airfoil and connected to one of the legs of the substantially closed loop cooling circuit.

6. : The air cooled turbine rotor blade of claim 1, and further comprising:
a row of film cooling holes extending along a leading edge region of the blade airfoil and connected to one of the legs of the substantially closed loop cooling circuit.
